(19) United States
(12) Patent Application Publication
(10) Pub. No.: US 2017/0303695 A1
(43) Pub. Date: Oct. 26, 2017

(54) HEATING INFLATABLE PRODUCT

(71) Applicant: Zhejiang Natural Travel Goods Co., Ltd., Taizhou City (CN)

(72) Inventors: Yonghui XIA, Taizhou City (CN); Zhiwang PAN, Taizhou City (CN); Jinglong CAO, Taizhou City (CN)

(21) Appl. No.: 15/215,932

(22) Filed: Jul. 21, 2016

(30) Foreign Application Priority Data
Apr. 21, 2016 (CN) 2016102558793

(51) Int. Cl. A47C 21/04; A47C 27/08; H05B 1/02

(52) U.S. Cl. CPC A47C 21/048; H05B 1/0272; A47C 27/081; H05B 1/02

(57) ABSTRACT

Provided is a heating inflatable product relating to the technical field of household products. The heating inflatable product includes an upper sheet, a lower sheet, a heating component and a power component, the heating component is arranged in an interlayer formed between the upper sheet and the lower sheet, and the upper sheet, the heating component and the lower sheet are arranged sequentially; and the power component is electrically connected with the heating component. The power component provides electric energy for the heating component to enable the heating component to heat, and the heating component is arranged adjacent to the upper sheet; therefore, the surface temperature of the upper sheet will increase gradually due to the existence of heat transfer, thereby improving the user experience.

### TECHNICAL FIELD

The present invention relates to the technical field of household products, and particularly to a heating inflatable product.

### BACKGROUND ART

A so called inflatable product refers to a product of a specific shape formed by defining an inflatable chamber with multiple peripheral sheets and then inflating the inflatable chamber. Inflatable products are widely used due to advantages of comfortableness, portability and softness, and such inflatable products include inflatable beds, inflatable sofas, inflatable toys, inflatable castles and so on. Among others, the peripheral sheets of most inflatable products are generally made from soft materials, and thus these inflatable products would be of a sphere shape, such as a shape of balloon, when being inflated if there is no supporting part provided within the inflatable chamber.

In the prior art, in order to prevent the inflatable product from becoming into a sphere, one or more pull straps are generally provided inside the inflatable chamber, and these pull straps are often connected with the peripheral sheets directly and play a supporting and shaping role. Therefore, depending on the positions where the pull straps are arranged within the inflatable chamber, the number of the pull straps and a shape defined by the peripheral sheets, the inflatable product may form a specific shape, such as a rectangular shape, and the like.

However, the inflatable products in the prior art generally do not have a heating function, and thus cause user experience to be degraded if being used in a cold environment.

### DISCLOSURE OF THE INVENTION

An object of the present invention is to provide a heating inflatable product, to solve the technical problem that the inflatable products in the prior art, when being used, cause user experience to be degraded due to lack of a heating function.

The heating inflatable product provided by the present invention includes an upper sheet, a lower sheet, a heating component and a power component, wherein the heating component is arranged in an interlayer formed between the upper sheet and the lower sheet, and the upper sheet, the heating component and the lower sheet are arranged sequentially; and the power component is electrically connected with the heating component.

Further, the heating component is made from an alloy fiber material.

Further, the heating component is a heating sheet, and the heating sheet is fixed onto an inner surface of the upper sheet arranged opposite to the lower sheet by means of bonding or sewing.

Further, there are a plurality of heating sheets, the plurality of heating sheets are arranged uniformly on an inner surface of the upper sheet arranged opposite to the lower sheet, and the plurality of heating sheets are connected in parallel with the power component.

Further, the heating inflatable product further includes a temperature control component, and the heating sheets are electrically connected with the power component through the temperature control component.

Further, the temperature control component is provided therein with a positive temperature coefficient thermistor, and the resistance of the positive temperature coefficient thermistor is adjusted through a change of temperature, to achieve adjustment of temperature grades.

Further, the heating inflatable product further includes a supporting part, and the supporting part is arranged in the interlayer formed between the upper sheet and the lower sheet.

Further, the supporting part includes a plurality of pull straps arranged at intervals, and outer surfaces of the pull strap arranged opposite to each other are connected respectively with an inner surface of the lower sheet and inner surfaces of the heating sheets which are arranged opposite to each other.

Further, the supporting part is a sponge, and the sponge is connected with the upper sheet and the lower sheet by means of bonding.

Further, the heating component is a shaped heating wire, gaps are provided on the sponge and the heating wire is embedded in the gaps.

Compared with the prior art, the present invention has the following beneficial effects:

the heating inflatable product provided by the present invention includes an upper sheet, a lower sheet, a heating component, a power component and a supporting part, wherein the heating component and the supporting part are arranged in an interlayer formed between the upper sheet and the lower sheet, and the upper sheet, the heating component, the supporting part and the lower sheet are arranged sequentially; and the power component is electrically connected with the heating component. The power component provides electric energy for the heating component to enable the heating component to heat, and the heating component is arranged adjacent to the upper sheet; therefore, the surface temperature of the upper sheet will increase gradually due to the existence of heat transfer, thereby improving the user experience.

### BRIEF DESCRIPTION OF DRAWINGS

In order to more clearly illustrate technical solutions of particular embodiments in the present invention and of the prior art, drawings which are needed for description of the particular embodiments or the prior art will be briefly introduced hereinafter. Apparently, drawings below merely show some embodiments of the present invention, and other drawings can also be obtained, in light of these drawings, by those skilled in the art without paying any creative efforts.

FIG. 1 is a schematic structural diagram of a heating inflatable product provided by an embodiment of the present invention;

FIG. 2 is a schematic exploded view of the heating inflatable product shown in FIG. 1;

FIG. 3 is a first schematic exploded view of a heating inflatable product provided by another embodiment of the present invention;

FIG. 4 is a second schematic exploded view of the heating inflatable product shown in FIG. 3;

FIG. 5 is a front view of the heating inflatable product shown in FIG. 3;

FIG. 6 is a schematic exploded view of a heating inflatable product provided by still another embodiment of the present invention; and

FIG. 7 is a schematic structural diagram of a sponge in the heating inflatable product shown in FIG. 6.

Reference signs are summarized as follows:

1—upper sheet, 2—lower sheet, 3—heating sheet, 4—pull strap, 5—sponge, 6—power component, 7—heating wire, and 8—gap.

### DETAILED DESCRIPTION OF EMBODIMENTS

The technical solutions of the present invention will be described clearly and completely hereinafter, in conjunction with drawings. Apparently, the embodiments described are some but not all of embodiments of the present invention. All of the other embodiments, obtained by those skilled in the art based on the embodiments of the present invention without paying any creative efforts, fall within the scope of protection of the present invention.

In the description of the present invention, it should be noted that orientational or positional relationships indicated by terms, such as “center”, “upper”, “lower”, “left”, “right”, “vertical”, “horizontal”, “inner”, and “outer”, are based on the orientational or positional relationships shown based on the drawings, merely for facilitating the description of the present invention and simplifying the description, rather than indicating or implying that the related devices or elements have to be in the specific orientation or configured and operated in the specific orientation, therefore they shall not be construed as limiting the present invention. Furthermore, terms, such as “first”, “second” and “third”, are only used for illustrative purposes, and shall not be construed as indicating or suggesting to have importance in relativity.

In the description of the invention, it should be noted that, unless otherwise expressly specified and defined, terms, such as “installation”, “joint” and “connection”, should be broadly interpreted. For example, it may be a fixed connection, a detachable connection, or an integrated connection; or it may be a mechanical connection or an electrical connection; or it may be a direct connection, or an indirect connection through an intermediate medium, and it also may be an inner communication between two elements. For those skilled in the art, specific meanings of the above-mentioned terms in the present invention can be understood based on specific situations.

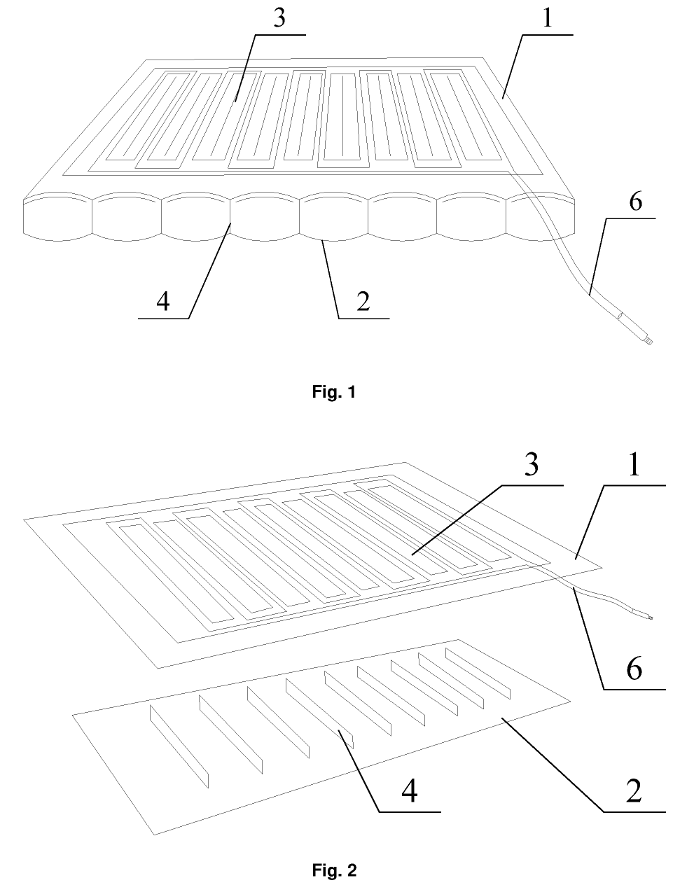

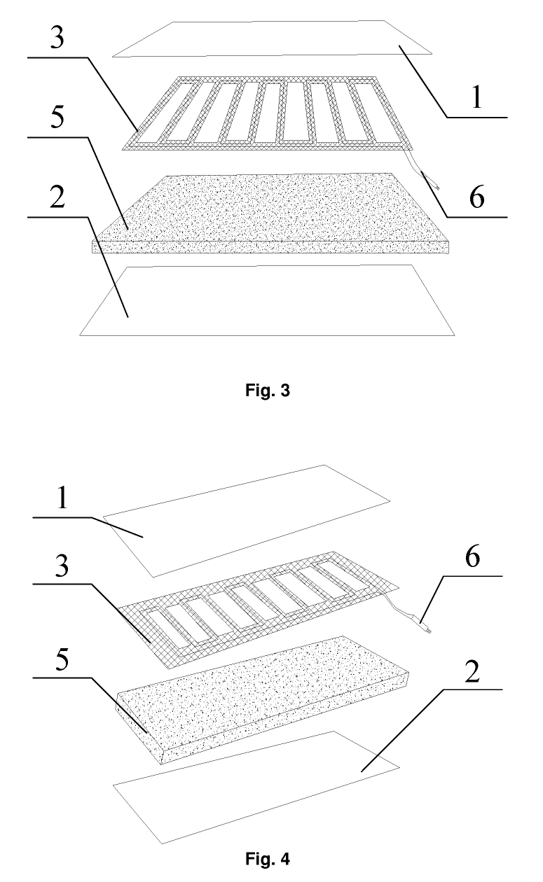

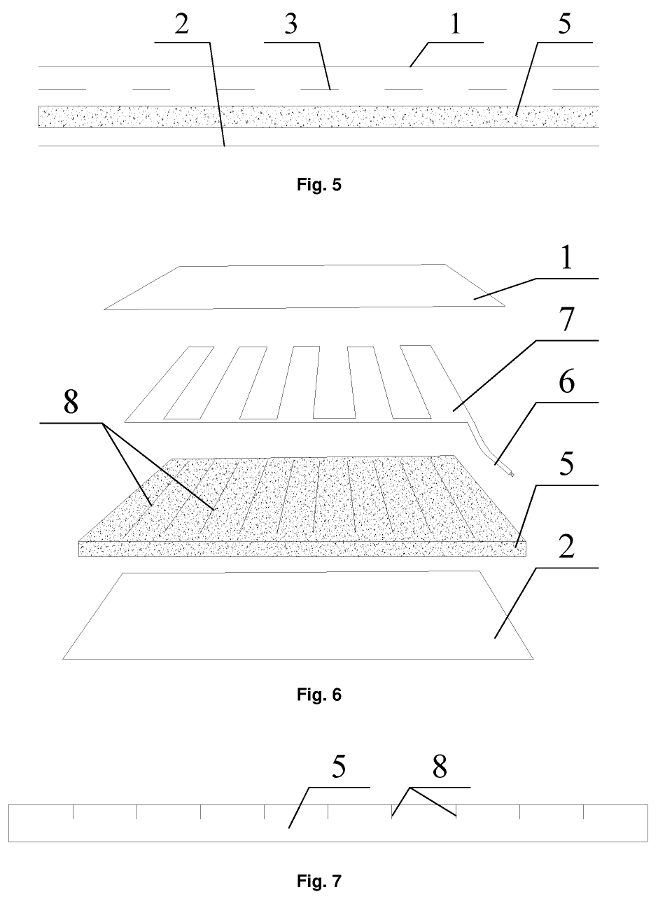

FIG. 1 is a schematic structural diagram of a heating inflatable product provided by an embodiment of the present invention; FIG. 2 is a schematic exploded view of the heating inflatable product shown in FIG. 1; FIG. 3 is a first schematic exploded view of a heating inflatable product provided by another embodiment of the present invention; FIG. 4 is a second schematic exploded view of the heating inflatable product shown in FIG. 3; FIG. 5 is a front view of the heating inflatable product shown in FIG. 3; FIG. 6 is a schematic exploded view of a heating inflatable product provided by still another embodiment of the present invention; and FIG. 7 is a schematic structural diagram of a sponge in the heating inflatable product shown in FIG. 6.

As shown in FIGS. 1 to 7, a heating inflatable product provided by an embodiment includes an upper sheet 1, a lower sheet 2, a heating component and a power component 6, wherein the heating component is arranged in an interlayer formed between the upper sheet 1 and the lower sheet 2, and the upper sheet 1, the heating component and the lower sheet 2 are arranged sequentially; and the power component 6 is electrically connected with the heating component.

The heating component mainly serves to dissipate heat when current passes therethrough. Therefore, the heating component illustrated in the embodiment may be any member capable of achieving the above-mentioned function, such as heating resistance wires, carbon fiber materials, graphene materials or alloy fiber materials, and the like.

As a preferable solution, the heating component provided in the embodiment is made from an alloy fiber material, where the alloy fiber generally refers to a material used for producing soft industrial metal. Due to the unique chemical element combination, the alloy fiber has good electrical conductivity and thermal conductivity, high strength, high elasticity, flexibility, wear resistance and corrosion resistance, and at the same time, the alloy fiber has properties of shielding, anti-magnetism, anti-radiation and low occurrence possibility of production of an electrostatic effect.

The heating component made from the alloy fiber may have characteristics of fast heating, high electricity-heat transformation rate, foldability, washability and sewability. Furthermore, the alloy fiber is soft and light, which makes the user feel better.

The power component 6 mainly serves to provide power support, i.e., provide electric energy for the heating component. There may be multiple selections, for example: a connector of a wire and a plug, where the plug may be connected to an external power source; or a portable power source and the like, wherein the portable power source may be a rechargeable lithium battery or a disposable battery, etc.

As a preferable solution, the power component 6 provided by the embodiment is a lithium battery, and a USB interface is provided on the lithium battery. The lithium battery can be repeatedly charged, and the USB interface makes it possible to charge mobile phones, notebook computers and other electronic products. With the above-mentioned structure, the range of application of the heating inflatable product provided by the embodiment may be effectively extended.

A heating inflatable product provided by the embodiment includes an upper sheet 1, a lower sheet 2, a heating component, a power component 6 and a supporting part, wherein the heating component and the supporting part are arranged in an interlayer formed between the upper sheet 1 and the lower sheet 2, and the upper sheet 1, the heating component, the supporting part and the lower sheet 2 are arranged sequentially; and the power component 6 is electrically connected with the heating component. The power component 6 provides electric energy for the heating component to enable the heating component to heat, and the heating component is arranged adjacent to the upper sheet 1; therefore, the surface temperature of the upper sheet 1 will increase gradually due to the existence of heat transfer, thereby improving the user experience. Furthermore, the supporting part is provided to support the upper sheet 1 and the lower sheet 2, to avoid a direct contact between the upper sheet 1 and the lower sheet 2 when the user sits or lies; meanwhile, it may ensure the heating inflatable product provided by the embodiment to have a specific shape.

Based on the above-mentioned embodiment, particularly, the heating component is a heating sheet 3, and the heating sheet 3 is fixed onto an inner surface of the upper sheet 1 arranged opposite to the lower sheet 2 by means of bonding or sewing.

If the heating sheets 3 are arranged onto the upper sheet 1 by means of bonding, an adhesive material may be coated on a surface of the heating sheet 3 and surfaces of the upper sheets 1, which are then jointed together by means of hot melting or high-frequency waves.

There are multiple selections for the adhesive material, for example glue, hot melt adhesive, or TPE (Thermoplastic Elastomer), TPU (Thermoplastic polyurethanes, Thermoplastic polyurethane elastomer rubber), TPR (Thermo-Plastic-Rubber material), TPV (Thermoplastic Vulcanizate), PVC (Polyvinyl chloride), TPO (Thermoplastic polyolefin, trimethylbenzoyl diphenylphosphine oxide), TPVC (Thermoplastic polyvinyl chloride elastomer), PVE (phenyl vinyl ether), EVA (Ethylene Vinyl Acetate, ethylene-vinyl acetate copolymer) or other high polymer materials.

When bonding the upper sheet 1 and the heating sheets 3, one or a combination of two or more of the above-mentioned adhesive materials may be used. Here, it is illustrated by taking the glue and the hot melt adhesive as an example: the glue is coated on the upper sheet 1 first, and then a layer of hot melt adhesive film is covered on the glue player so as to increase the adhesion, thereby ensuring a firm bonding between the upper sheet 1 and the heating sheets 3.

Based on the above-mentioned embodiment, particularly, there are a plurality of heating sheets 3, the plurality of heating sheets 3 are uniformly arranged on an inner surface of the upper sheet 1 arranged opposite to the lower sheet 2, and the plurality of heating sheets 3 are connected in parallel with the power component 6.

The plurality of heating sheets 3 are provided, and the plurality of heating sheets 3 are connected in parallel with the power component 6, in this way, even when one of the heating sheets 3 fails to work due to damage, other heating sheets can still work normally, thereby greatly reducing the occurrence probability that the heating inflatable product provided by the embodiment fails to heat.

Based on the above-mentioned embodiment, particularly, a temperature control component is further included, and the heating sheets 3 are electrically connected with the power component 6 through the temperature control component.

The temperature control component is provided for adjusting among grades, to control the output power of the power component 6. In the embodiment, the temperature control component has three grades: a low grade corresponding to a temperature of 26° C.−32° C.; a middle grade corresponding to a temperature of 32° C.−36° C.; and a high grade corresponding to a temperature of 36° C.−45° C. In the case of the high grade of the power component 6, the electric quantity of the power component 6 may be available for 8 hours, which fully satisfies the sleep time requirement of the user.

As a preferable solution, an indicator light, a display screen, a lighting device and other components may also be provided on the temperature control component, so as to facilitate use at night of the heating inflatable product provided by the embodiment.

Based on the above-mentioned embodiment, particularly, a temperature sensor may further be included. The temperature sensor is arranged within the heating sheet 3, and the temperature sensor is connected with the temperature control component, so as to achieve adjustment of temperature grades.

The individual grades of the temperature control component correspond to different threshold temperatures. The actual temperature of the heating sheet 3 is detected by the temperature sensor, and the heating operation is started or stopped when the detected actual temperature reaches the threshold temperature, so that the heating sheet 3 can always remain at a suitable set temperature automatically.

Based on the above-mentioned embodiment, particularly, the temperature control component is provided therein with a positive temperature coefficient thermistor, and the resistance of the positive temperature coefficient thermistor is adjusted through a change of temperature, to achieve adjustment of the temperature grades.

As the temperatures of the heating sheets 3 increase to a set value, the resistance of the positive temperature coefficient thermistor increases significantly, thereby reducing the intensity of current and suspending the heating of the alloy fiber. After the temperatures of the heating sheets 3 decrease, the resistance of the positive temperature coefficient thermistor decreases accordingly, thereby increasing the intensity of current and improving the heating strength of the alloy fiber.

The temperature control is achieved by the positive temperature coefficient thermistor with its own properties, thereby simplifying the circuit and increasing the reliability of the temperature control component.

Based on the above-mentioned embodiment, particularly, a supporting part is further included, and the supporting part is arranged in an interlayer formed between the upper sheet 1 and the lower sheet 2.

The supporting part mainly serves to play a role in supporting the heating inflatable product, thereby ensuring the heating inflatable product to have a specific shape, such as a quadrate or circular shape and so on. Of course, the supporting part may also prevent the heating inflatable product provided by the embodiment from being squashed under a greater pressure.

Based on the above-mentioned embodiment, particularly, as shown in FIGS. 1 and 2, the supporting part includes multiple pull straps 4 arranged at intervals, and two ends of the pull straps 4 are connected respectively with an inner surface of the lower sheet 2 and inner surfaces of the heating sheets 3 which are arranged opposite to each other.

It should be noted that, if the heating sheets 3 have hollowed regions, the adhesive material may be coated on the pull straps 4 and the upper sheet 1, and the heating sheets 3 may be fixed when the pull straps 4 are bonded onto the upper sheet 1. If the heating sheets 3 do not have hollowed regions, the adhesive material requires to be coated on the inner surface of the upper sheet 1, on both surfaces of the heating sheets 3 and on the pull straps 4, to bond them together. Therefore, preferably, a hollowed region is provided on the upper sheet 3, so as to save the consumed amount of the adhesive material, thereby saving cost while lowering the weight.

As a preferable solution, particularly, the pull strap 4 includes a first pull strap sheet and a second pull strap sheet arranged opposite to each other and a third pull strap sheet and a fourth pull strap sheet arranged opposite to each other, wherein a first bonding layer is provided on both the first pull strap sheet and the second pull strap sheet, while no bonding layer is provided on the third pull strap sheet and the fourth pull strap sheet. As to the pull straps 4 provided by the embodiment, since the first bonding layer is only arranged on the first pull strap sheet and the second pull strap sheet, the production cost and the weight of the pull straps 4 may be effectively reduced.

The first pull strap sheet, the second pull strap sheet, the third pull strap sheet and the fourth pull strap sheet may be a sheet-shaped fabric in an integrated design, wherein the sheet-shaped fabric may be folded into a ring shape, and two planes arranged opposite to each other thereof are respectively the first pull strap sheet and the second pull strap sheet, or the third pull strap sheet and the fourth pull strap sheet.

Of course, the first pull strap sheet, the second pull strap sheet, the third pull strap sheet and the fourth pull strap sheet may also adopt a split-type design. That is, the first pull strap sheet, the second pull strap sheet, the third pull strap sheet and the fourth pull strap sheet, which are the same, may be connected with each other, to form the pull strap 4 in an enclosed manner. In the case of the split-type design, there may be multiple selections for the way of connecting the first pull strap sheet, the second pull strap sheet, the third pull strap sheet and the fourth pull strap sheet, such as sewing, bonding or welding and the like.

Based on the above-mentioned embodiment, particularly, the material of the first pull strap sheet, the material of the second pull strap sheet, the material of the third pull strap sheet and the material of the fourth pull strap sheet may be different from each other; or also all of these materials may be the same; or two of these materials are the same, and the other two of these materials are the same, and so on. For example, both the first pull strap sheet and the second pull strap sheet are made from cotton, non-woven, polyester fabric or nylon fabric, and both the third pull strap sheet and the fourth pull strap sheet are made from porous fabric, cotton, non-woven, polyester fabric or nylon fabric.

Since the porous fabric is lighter and has a relatively cheap price, as a preferable solution, the third pull strap sheet and the fourth pull strap sheet may be made from the porous fabric so as to further lower the production cost and the whole weight of the pull straps 4. The porous fabric illustrated in the embodiment refers to a fabric with multiple holes, for example mesh fabric, gauze or cotton net.

Among others, the mesh of the porous fabric may be of a honeycomb shape, a square shape or a diamond shape. Compared with the honeycomb-shaped mesh, the square-shaped mesh and the diamond-shaped mesh provide poor tensile resistance. Therefore, the mesh of the mesh fabric illustrated in the embodiment is preferably of a honeycomb shape. Selection of the mesh fabric with the honeycomb-shaped mesh may effectively save materials on the premise of ensuring a good strength.

Based on the above-mentioned embodiment, particularly, as shown in FIGS. 3 to 5, the supporting part is a sponge 5, and the sponge 5 is connected with the upper sheet 1 and the lower sheet 2 by means of bonding.

Particularly, the sponge 5 is arranged between the heating sheets 3 and the lower sheet 2. In a case that the heating sheets 3 have hollowed regions, the sponge 5 is directly connected to the upper sheet 1; and in a case that the heating sheets 3 do not have hollow regions, the sponge 5 is connected to the upper sheet 1 via the heating sheets 3, that is, the heating sheets 3 are first bonded onto the upper sheet 1, and then the sponge 5 is bonded onto the heating sheets 3.

There are multiple selections for the way of connecting the sponge 5 with the upper sheet 1, the heating sheets 3 or the lower sheet 2, such as bonding or sewing. In order to facilitate the operation, bonding is selected in this embodiment.

There are multiple selections for the adhesive material used for bonding the sponge 5 onto the upper sheet 1, the heating sheets 3 or the lower sheet 2, for example glue, hot melt adhesive, or TPE (Thermoplastic Elastomer), TPU (Thermoplastic polyurethanes, Thermoplastic polyurethane elastomer rubber), TPR (Thermo-Plastic-Rubber material), TPV (Thermoplastic Vulcanizate), PVC (Polyvinyl chloride), TPO (Thermoplastic polyolefin, trimethylbenzoyl diphenylphosphine oxide), TPVC (Thermoplastic polyvinyl chloride elastomer), PVE (phenyl vinyl ether), EVA (Ethylene Vinyl Acetate, ethylene-vinyl acetate copolymer) or other high polymer materials.

By using the sponge 5 as the supporting part, when the heating inflatable product provided by the embodiment is not inflated, the sponge 5 is in a compressed state, and in this case, the heating inflatable product has a small volume, facilitating carrying; and when needing to be inflated, only an air valve requires to be opened to allow air to enter into pores of the sponge 5 via the air valve, such that the sponge 5 expands gradually, so as to blow the heating inflatable product up. By using the sponge 5 as the supporting part, an object of self-inflating may be achieved without inflating with an electric air pump, and therefore, energy is also saved.

Based on the above-mentioned embodiment, particularly, as shown in FIGS. 6 and 7, the heating component is a shaped heating wire 7, gaps 8 are provided on the sponge 5 and the heating wire 7 is embedded in the gaps 8.

By providing the heating wire 7 on the sponge 5 in an embedded manner, the bonding process is avoided, thus improving the production efficiency on one hand, and reducing the whole weight and the cost of the heating inflatable product provided by the embodiment on the other hand.

Finally, it should be noted that, all of the embodiments above are only illustrative of the technical solutions of the present invention, and not limiting. Although the present invention have been detailed with reference to the foregoing embodiments, those skilled in the art shall understand that they may make modifications to the technical solutions as illustrated by the foregoing embodiments or make equivalent substitutions to part or all of the technical features. Such modifications and substitutions shall not cause the essence of the respective technical solutions to depart from the scope of the technical solutions as illustrated by the embodiments of the present invention.

1. A heating inflatable product, comprising an upper sheet, a lower sheet, a heating component and a power component, wherein the heating component is arranged in an interlayer formed between the upper sheet and the lower sheet, and the upper sheet, the heating component and the lower sheet are arranged sequentially; and the power component is electrically connected with the heating component.

2. The heating inflatable product according to claim 1, wherein the heating component is made from an alloy fiber material.

3. The heating inflatable product according to claim 1, wherein the heating component is a heating sheet, and the heating sheet is fixed onto an inner surface of the upper sheet arranged opposite to the lower sheet by means of bonding or sewing.

4. The heating inflatable product according to claim 1, wherein there are a plurality of heating sheets, the plurality of heating sheets are arranged uniformly on an inner surface of the upper sheet arranged opposite to the lower sheet, and the plurality of heating sheets are connected in parallel with the power component.

5. The heating inflatable product according to claim 1, further comprising a temperature control component, wherein the heating sheets are electrically connected with the power component through the temperature control component.

6. The heating inflatable product according to claim 5, wherein the temperature control component is provided therein with a positive temperature coefficient thermistor, and the resistance of the positive temperature coefficient thermistor is adjusted through a change of temperature, to achieve adjustment of temperature grades.

7. The heating inflatable product according to claim 1, further comprising a supporting part, wherein the supporting part is arranged in the interlayer formed between the upper sheet and the lower sheet.

8. The heating inflatable product according to claim 7, wherein the supporting part comprises a plurality of pull straps arranged at intervals, and outer surfaces of the pull strap arranged opposite to each other are connected respectively with an inner surface of the lower sheet and inner surfaces of the heating sheets which are arranged opposite to each other.

9. The heating inflatable product according to claim 7, wherein the supporting part is a sponge, and the sponge is connected with the upper sheet and the lower sheet by means of bonding.

10. The heating inflatable product according to claim 9, wherein the heating component is a shaped heating wire, gaps are provided on the sponge and the heating wire is embedded in the gaps.

11. The heating inflatable product according to claim 2, further comprising a temperature control component, wherein the heating sheets are electrically connected with the power component through the temperature control component.

12. The heating inflatable product according to claim 3, further comprising a temperature control component, wherein the heating sheets are electrically connected with the power component through the temperature control component.

13. The heating inflatable product according to claim 4, further comprising a temperature control component, wherein the heating sheets are electrically connected with the power component through the temperature control component.

14. The heating inflatable product according to claim 2, further comprising a supporting part, wherein the supporting part is arranged in the interlayer formed between the upper sheet and the lower sheet

15. The heating inflatable product according to claim 3, further comprising a supporting part, wherein the supporting part is arranged in the interlayer formed between the upper sheet and the lower sheet

16. The heating inflatable product according to claim 4, further comprising a supporting part, wherein the supporting part is arranged in the interlayer formed between the upper sheet and the lower sheet
